(19) United States
(12) Patent Application Publication
(10) Pub. No.: US 2004/0080121 A1
(43) Pub. Date: Apr. 29, 2004

(54) Seal arrangement for an expansion motion joint

(76) Inventors: Frank Fieger, Velbert (DE); Andreas Trawicki, Oberhausen (DE)

Correspondence Address: FASSE PATENT ATTORNEYS, P.A., P.O. BOX 726, HAMPDEN, ME, 04444-0726, US

(21) Appl. No.: 10/377,126

(22) Filed: Feb. 26, 2003

(30) Foreign Application Priority Data
Feb. 27, 2002 (DE) 102 08 359.2

(51) Int. Cl. F16J 15/02

(52) U.S. Cl. 277/628

(57) ABSTRACT

In a sealing apparatus 1a for an expansion joint 2 between two structure bodies 4 with a flexible bridging unit 13a and two anchoring units 8a which are arranged on opposite sides of the expansion joint 2 and each comprise an integral flange 9a which can be connected with the associated structure body and a lapped flange 10a which can be braced by means of a clamping element 11a with the integral flange 9a in the manner of a dovetail connection, with the bridging unit being connectable with the anchoring units in such way that it is clamped between the integral flange 9a and the lapped flange, the clamping element 11a substantially has the same strength as the integral flange 9a.

### BACKGROUND OF THE INVENTION

The invention relates to a sealing apparatus for an expansion joint between two structure bodies with a flexible bridging unit and two anchoring units which are situated on opposite sides of the expansion joint and each comprise an integral flange which can be connected with the structure body and a lapped flange which can be braced with the integral flange by means of a clamping element in the manner of a dovetail joint, with the bridging unit being connectable with anchoring units in such a way that it is clamped between the integral flange and lapped flange.

Sealing apparatuses are used for example for bridging expansion joints between concrete slabs in order to cover the expansion joint and to prevent the penetration of foreign bodies or liquids on the one hand and to allow secure driving and walking on parking decks without placing excessive loads on the mutually opposite edges of the structure bodies. Generally known sealing apparatuses comprise two anchoring units which are each connected with the structure bodies at mutually opposite edges and between which a substantially elastic bridging unit is braced.

Each anchoring unit substantially consists of an integral flange and a lapped flange, with the integral flange being fixedly connected with the respective structure body by means of screwed connections for example. The lapped flange can be connected with the integral flange in such a way that the bridging unit is clamped in a gap formed between the two. Generally known are sealing apparatuses in which the lapped flange is connected with the integral flange by means of a screwed connection penetrating the bridging unit. Such sealing apparatuses have proven to be disadvantageous because an opening is mandatorily produced with the penetration of the bridging unit which allows the penetration of humidity to the integral flange and to the expansion joint. The screwed connected ranging from the surface of the anchoring unit to the integral flange further constitutes an electrically as well as thermally conductive connection to the structure body. Such conductive connections are frequently undesirable both for security reasons as well as bridges for the cold.

A sealing apparatus of the above generic kind is known from EP 1 158 101 A2. The integral flange comprises a dovetail-like groove through whose opening cross section at first the bridging unit and then a clamping element connected with the lapped flange can be guided during the mounting. By shortening a press element, the clamping element is elastically compressed and widens in the direction of the width of the groove. In this way it presses against the mutually opposite bearing surfaces of the groove that in this region a non-positive connection is achieved between the integral flange, the bridging unit, the clamping element and the lapped flange. The use of a dovetail connection with an elastic clamping element already eliminates the disadvantageous penetration of the bridging unit and further facilitates and accelerates the mounting of the sealing apparatus.

One disadvantage of the sealing apparatus according to EP 1 158 101 A2 is the fact, however, that the connection of the lapped flange with the integral flange, and thus also the fixing of the bridging unit, is considerably less tight as in known screwed connections. It is feared that when driving over such a sealing apparatus transversally to the expansion joint, especially in the case of extreme acceleration or braking processes of truck vehicles for example, the clamping element pressed into the groove would be unable to withstand the occurring shearing forces transversally to the longitudinal axis of the sealing apparatus and could be tom out of said groove with the lapped flange.

### SUMMARY OF THE INVENTION

The invention is based on the object of providing a sealing apparatus for bridging an expansion joint whose connection of lapped flange and integral flange will also meet the extreme requirements when being driven over and which can be mounted easily and quickly without penetrating the bridging unit.

### SOLUTION

Based on the generic known sealing apparatus, this object is achieved in accordance with the invention in such a way that the clamping element substantially has the same strength as the integral flange. If the lapped flange is braced by means of said clamping element with the integral flange in the manner of a dovetail connection, the strength of the connection is not limited by the material of the clamping element. A displacement of the lapped flange with respect to the integral flange is only given within the scope of the pressing capability of the bridging unit which is clamped between the two. An elastic deformation of the clamping element and the tearing out from the connection under excessive load need not be anticipated.

The sealing apparatus in accordance with the invention is arranged in the manner for example that an integral flange comprises a dovetail-like spring extending in the longitudinal direction of the sealing apparatus on whose mutually opposite bearing surfaces rest on the one hand the lapped flange and on the other hand the clamping element. The sealing apparatus can then be mounted in an especially simple manner because the delivery of the lapped flange and clamping element to the respective bearing surfaces is not obstructed.

A sealing apparatus in accordance with the invention is preferable to this, however, whose integral flange comprises a dovetail-like groove, with the clamping element being made to rest on one or both mutually opposite bearing surfaces of the groove. The groove is then open in the direction towards the lapped flange. For the purpose of mounting such a sealing apparatus the clamping element is introduced through an opening cross section of the groove into the same. The clamping element is advantageously arranged in such a way that, when it is tilted thereafter about the longitudinal axis of the groove, it can no longer be removed from the groove (without tilting).

The sealing apparatus in accordance with the invention preferably comprises a screw for connection of the lapped flange and clamping element, with the screw head resting on the lapped flange. Such an arrangement simplifies and accelerates the mounting and thus lowers the production costs of the sealing apparatus. Especially preferably screws with a self-cutting thread are used which engage in the clamping element in a groove extending in the longitudinal direction of the sealing apparatus. On the one hand, this enables the production of the clamping element as a continuous or “off the hook” merchandise. On the other hand, mounting is facilitated in such a way that no fixed position of the clamping element with respect to the lapped flange needs to be observed.

The bridging unit of a sealing apparatus in accordance with the invention can be equipped with a sealing lip extending in the longitudinal direction of the sealing apparatus, which sealing lip is inserted during the mounting of the sealing apparatus into a respective groove of the integral flange. Such a sealing lip improves the sealing effect of the sealing apparatus. Moreover, the mounting of the sealing apparatus is also facilitated in this way because the region of the bridging unit inserted into the dovetail connection is pulled out by its weight.

### BRIEF DESCRIPTION OF THE DRAWINGS

Embodiments of the sealing apparatus in accordance with the invention are shown below in the drawings which are used to explain the invention in closer detail, wherein:

FIG. 1 shows a cross-sectional view through a first sealing apparatus;

FIG. 2 shows a sectional view of said first sealing apparatus;

FIGS. 3a to 3h show phases for mounting said first sealing apparatus, and

FIGS. 4a and 4b show phases for mounting a second sealing apparatus.

### DETAILED DESCRIPTION OF THE PREFERRED EMBODIMENTS

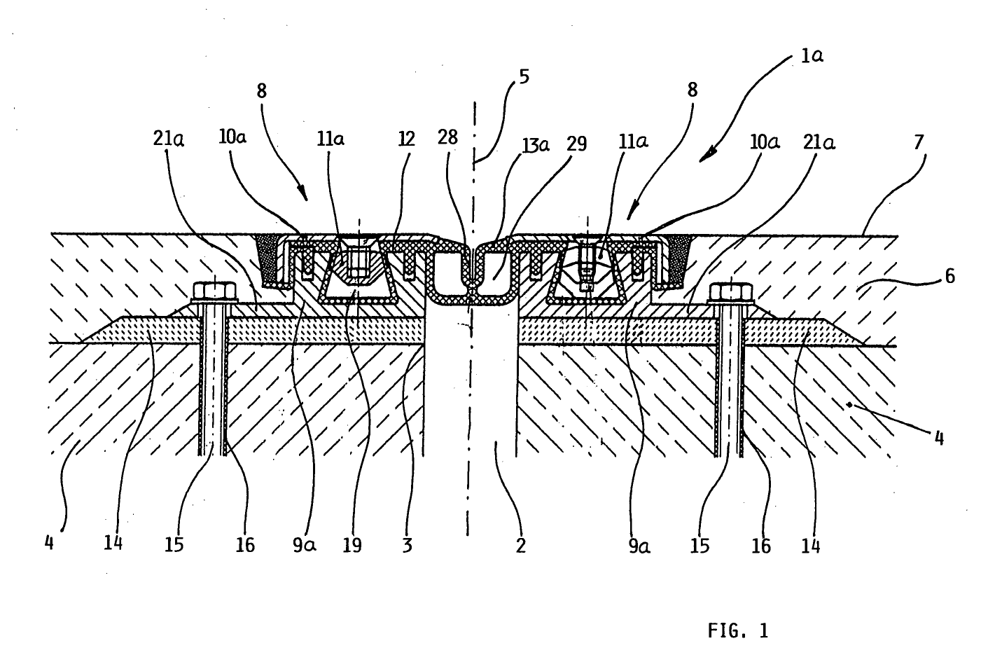

The sealing apparatus 1a covers and protects the upwardly open expansion joint 2 between the mutually opposite edges 3 of two structure bodies 4. FIG. 1 shows this arrangement in a sectional view perpendicular to the longitudinal direction of the expansion joint 2. The sealing apparatus 1a, which is shown here in an exemplary manner, is arranged in a mirror-symmetrical fashion relative to a perpendicularly extending central plane 5 of the expansion joint 2. Sealing apparatuses (not shown herein) without such a symmetry are used for other applications.

The structure bodies 4 each comprise a useful layer 6 (which in this case is an asphalt paving). An anchoring unit 8a is flush with the drivable surface 7 of said layer at the two edges 3 of the structure body 4. The anchoring units 8a each comprise an integral flange 9a and a lapped flange 10a which are braced by means of clamping elements 11a in the manner of a dovetail connection and which hold in a gap 12a between the integral flange 9a and the lapped flange 10a a rubber-elastic bridging unit 13a which spans the expansion joint 2. The integral flanges 9a are held on a compensating layer 14 and are anchored in the structure bodies 4 by means of screws 15 and dowels 16.

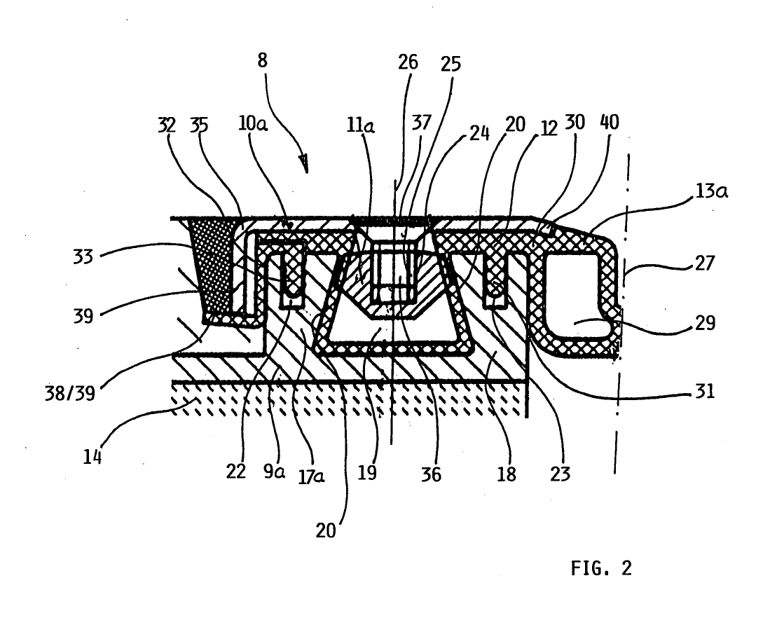

FIG. 2 shows in an enlarged detail of the sealing apparatus 1a the connection of an integral flange 9a and the associated lapped flange 10a. The integral flange 9a comprises an upwardly open dovetail groove 19 with mutually opposite bearing surfaces 20a between a holding leg 17a and a relief leg 18. The holding leg 17a and the relief leg 18 project beyond a horizontally extending end section 21a of the integral flange 9a and provide the same with the shape of an F. The holding leg 17a and the relief leg 18 are provided with rectangular sealing grooves 22 and 23. The holding leg 17a, the relief leg 18, the dovetail groove 19, the end section 21a and the sealing grooves 22 and 23 extend perpendicular to the illustrated sectional view in the longitudinal direction of the integral flange 9a configured as an aluminum extruded profile.

The lapped flange 10a is a strip of steel sheet with a cross section which is bent off in an L-shaped manner and comprises a plurality of sunk bores 24a arranged successively behind each other at the same distance in its longitudinal direction extending perpendicular to the illustrated sectional view. The clamping element 11a comprises a substantially hexagonal cross section and a groove 25a extending in its longitudinal direction and is arranged in a mirror-symmetrical fashion with respect to a central plane 26a of the groove 25a. The clamping element 11a is also made from an aluminum extruded profile.

The rubber-elastic bridging unit 13a is provided with a mirror-symmetrical arrangement with respect to a central plane 27 extending in its longitudinal direction perpendicular to the illustrated section view. In the mounted state, the bridging unit 13a comprises in said central plane 27 a groove 28a which is open in the direction of the useful layer 6, which groove is bordered on either side by a substantially rectangular, closed hollow profile 29a and, adjacent thereto, a thin holding strip 30a The holding strips 30a are placed on the hollow profiles 29a in such a way that, when mounting occurs, both are flush in the direction of the useful layer 6. On the side averted from the useful layer 6, a sealing lip 31 each is shaped on the holding strips 30a.

When mounting the illustrated sealing apparatus 1a, the integral flanges 9a are aligned at first with the opposite edges 3 of the structure bodies 4 on the compensating layer 14 and then fixed. The useful layer 6 is then applied. Thereafter the rubber-elastic supplementary strips 32 are positioned which engage with the sealing lip 33 in the sealing grooves 22 of the holding legs 17a. The sealing lips 33 are provided with a toothing (not shown) against inadvertent extraction from the sealing grooves 22. The supplementary strips 32 grasp around the holding legs 17a and end on the useful layer 6 which is sunk with respect to surface 7 after the integral flanges 9a.

The bridging unit 13a is then positioned in such a way that the holding strips 30a engage in the dovetail grooves 19 and the sealing lips 31 as mounting aids in the sealing grooves 23 of the relief legs 18. The holding strips 30a overlap in the region of the holding legs 17a with the supplementary strips 32 and, together with the same, ensure an effective sealing in the direction towards the surface 7.

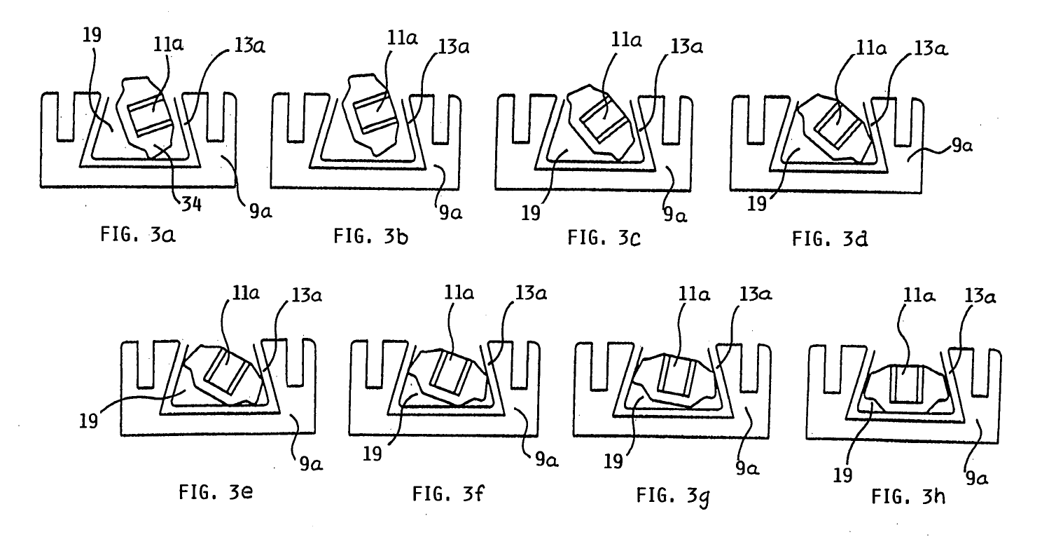

FIGS. 3a to 3h show a schematically strongly simplified representation of successive stages of the now occurring insertion of the clamping element 11a into the dovetail groove 19 in which a holding strip 30a of the bridging unit 13a is already positioned. The clamping element 11a is swiveled according to FIG. 3a relative to the mounting position about its longitudinal axis by approximately 90° and introduced with a narrow side 34 at first into the dovetail groove 19, swiveled back about its longitudinal axis according to FIGS. 3b to 3g until its rests, as is shown in FIG. 3h, in the mounting position in the dovetail groove 19. Without a renewed swiveling of the clamping element 11a about its longitudinal axis the same cannot be removed from the dovetail groove 19 again.

The lapped flange 10a is then placed in such a way that the shorter, bent leg 35 of the lapped flange 10a grasps around the holding leg 17a of the integral flange 9a. Self-cutting countersunk head screws 36 are introduced into the groove 25a of the clamping element 11a through the bores 24a of the lapped flange 10a.

By tightening the countersunk head screws 36, whose heads 37 rest on the sunk bores 24a of the lapped flange 10a, the clamping element 11a in the dovetail groove 19 is pulled in the direction towards the lapped flange 10a and rests on the mutually opposite bearing surfaces 20a of the dovetail groove 19. In this way the lapped flange 10a is fixedly connected with the integral flange 9a on the one hand. On the other hand, the holding strip 30a of the bridging unit 13a resting in the dovetail groove 19 is clamped between the bearing surfaces 20a of the dovetail groove 19 and the clamping element 11a and is fixed in its position.

To complete the mounting of the illustrated sealing apparatus 1a, the intermediate space 38 formed between the bent leg 35 of the lapped flange 10a and the useful layer 6 is filled with a jointing compound 39.

The lapped flange 10a and the jointing compound 39 are flush with the drivable surface 7 of the useful layer 6, so that an arrangement is obtained which can be driven over in a substantially jolt-free fashion by a vehicle (not shown) in connection with a comparatively small offset between the lapped flange 10a and the bridging unit 13a above the expansion joint 2. Horizontal forces which are introduced into the lapped flange 10a are supported via the bent leg 35 of the lapped flange 10a and the comparatively stiff-jointing compound 39a in the useful layer 6. The clamping elements 11a are therefore not subjected to any considerable dynamic horizontal forces.

The same effect of horizontal force relief of the clamping elements 11a is achieved by a convexly curved edge strip 40 of the lapped flange 10 which faces the expansion joint 2 and which projects into the gap cross section via the relief leg 18. Since the bridging unit 13a above the expansion joint 2 is slightly offset in a rearward fashion with respect to the drivable surface 7 of the useful layer 6, the same is nearly completely protected from contact with the vehicle wheels.

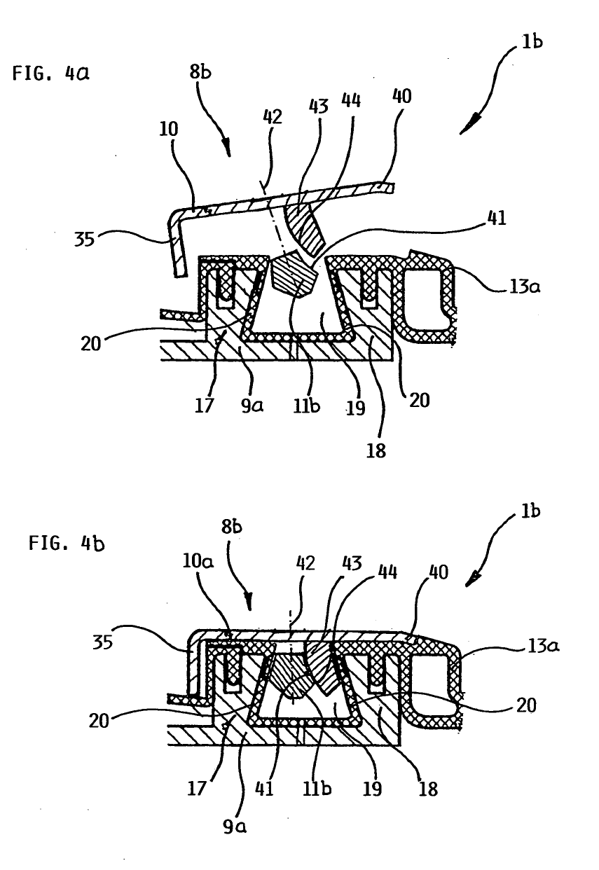

The sealing apparatus 1b as shown in FIGS. 4a and 4b in a sectional view according to FIG. 2 differs from the sealing apparatus 1a of FIG. 1 merely by a configuration of the lapped flange 10b and the clamping element 11b which differs with respect to the same.

The clamping element 11b in the FIGS. 4a and 4 shows a substantially hexagonal cross section. In comparison with the clamping element 11a of the sealing apparatus 1a of FIG. 1 the width is clearly reduced and a contact surface 41 is curved in a concave fashion. The clamping element 11b further does not comprise a groove, but bores (not shown) in the direction of the illustrated central line 42, which bores are arranged in a successive manner in the longitudinal direction of the clamping element which extends perpendicular to the illustrated sectional view. The clamping element 11b is also made as a continuous extruded aluminum profile.

Like the lapped flange 10a of the sealing apparatus 1a of FIG. 1, the lapped flange 10b of FIGS. 4a and 4b is a sheet steel strip with a cross section bent off in an L-shaped manner which comprises a plurality of sunk bores (not shown) in the direction of the central line 42, which bores are disposed in a successive fashion in its longitudinal direction extending perpendicularly to the illustrated sectional view. A supporting element 43 made of a continuously drawn steel profile is welded together with the lapped flange 10b. The supporting element 43 has a substantially rectangular cross section, with a contact surface 44 being curved in a convex manner according to the contact surface 41 of the clamping element 11b.

For the purpose of mounting the sealing apparatus 1b the lapped flange 10b is pre-mounted with the clamping element 11b by means of screws (again not shown) engaging through the bores of the lapped flange 10b in the bores of the clamping element 11b. As in the sealing apparatus 1a of FIG. 1, self-cutting countersunk head screws are used in this case as well.

When the lapped flange 10b is positioned, its shorter, bent-off leg 35 grasps around the holding leg 17a of the integral flange 9a At the same time, the clamping element 11b, which is suspended by means of the screws (not shown) and moves in a loose pendulum fashion, is introduced into the dovetail groove 19.

By tightening the screws (not shown) whose heads on their part rest on the sunk bores (not shown) of the lapped flange 10b, the clamping element 11b is pulled in the dovetail groove 19 in the direction towards the lapped flange 10b and rests on the one hand with its concavely curved contact surface 41 on the convexly curved contact surface 44 of the supporting element 43 and, via the same, on a bearing surface 20 of the dovetail groove 19, and on the other hand directly on the opposite bearing surface 20 of the dovetail groove 19.

In this case too the lapped flange 10b is fixedly connected with the integral flange 9a on the one hand. On the other hand, the holding strip 30 of the bridging unit 13 resting in the dovetail groove 19 is clamped between the bearing surfaces 20 of the dovetail groove 19 and the clamping element 11b and is fixed in its position. In comparison with the sealing apparatus 1a of FIG. 1, the mounting of the sealing apparatus 1b in FIGS. 4a and 4b is again clearly simplified and accelerated.

1. A sealing apparatus (1a, 1b) for an expansion joint (2) between two structure bodies (4) with a flexible bridging unit (13a) and two anchoring units (8a) which are situated on opposite sides of the expansion joint (2) and each comprise an integral flange (9a) which can be connected with the associated structure body (4) and a lapped flange (10a, 10b, 10c) which can be braced with the integral flange (9a) by means of a clamping element (11a, 11b) in the manner of a dovetail joint, with the bridging unit (13a) being connectable with anchoring units (8a) in such a way that it is clamped between integral flange (9a) and lapped flange (10a, 10b), characterized in that the clamping element (11a, 11b) substantially comprises the same strength as the integral flange (9a).

2. A sealing apparatus according to claim 1, characterized in that an integral flange comprises a dovetail-like spring extending in the longitudinal direction of the sealing apparatus with two mutually opposite bearing surfaces, with the lapped flange and the clamping element being braceable with the integral flange in such a way that the lapped flange rests on the one bearing surface and the clamping element on the other bearing surface.

3. A sealing apparatus (1a, 1b) according to claim 1, characterized in that an integral flange (9a) comprises a dovetail-like groove (19) extending in the longitudinal direction of the sealing apparatus (1a, 1b) with two mutually opposite bearing surfaces (20a), with the lapped flange (10a, 10b) and the clamping element (11a, 11b) being braceable with the integral flange (9a) in such a way that the clamping element (11a, 11b) rests on at least one of the bearing surfaces (20a).

4. A sealing apparatus (1a, 1b) according to the preceding claim, characterized in that a clamping element (11a, 11b) can be introduced through an opening cross section of the groove (19) into the same and can be tilted in the groove (19) about its longitudinal axis to such a position that a removal of the clamping element (11a, 11b) from the groove (19) requires a renewed tilting.

5. A sealing apparatus (1a, 1b) according to at least one of the preceding claims, characterized in that the lapped flange (10a, 10b) and the clamping element (11a, 11b) of an anchoring unit (8a) can be connected with screws (36) whose heads (37) rest on the lapped flange (10a, 10b).

6. A sealing apparatus (1a) according to the preceding claim, characterized in that the clamping element (11a) comprises a groove (25) extending in the longitudinal direction, that the screws (36) have a self-cutting thread and that the lapped flange (10a) can be connected with the clamping element (11a) by introducing said screws (36) into said groove (25).

7. A sealing apparatus (1a, 1b) according to at least one of the preceding claims, characterized in that the bridging unit (13a) comprises a sealing lip (31) which extends in the longitudinal direction of the sealing apparatus (1a, 1b) and which can be inserted into a respective sealing groove (23) of the integral flange (9a).
